(19) United States
(12) Patent Application Publication
(10) Pub. No.: US 2024/0262961 A1
(43) Pub. Date: Aug. 8, 2024

(54) NEW PHOSPHONATED NON-FLUORINATED AND PARTIALLY FLUORINATED ARYL POLYMERS FROM SULFONATED ARYL POLYMERS AND NEW POLYMERIC PERFLUOROPHOSPHONIC ACIDS FROM PERFLUOROSULFONIC ACIDS, THEIR PROCESS OF PREPARATION AND USE IN ELECTROMEMBRANE APPLICATIONS

(71) Applicant: Riva Power Systems GmbH & Co. KG, Backnang (DE)

(72) Inventor: Andreas CHROMIK, Rudersberg (DE)

(73) Assignee: Riva Power Systems GmbH & Co. KG, Backnang (DE)

(21) Appl. No.: 18/566,734

(22) PCT Filed: Sep. 28, 2023
(86) PCT No.: PCT/DE2022/100466

§ 371 Date: Dec. 4, 2023

(30) Foreign Application Priority Data
Jun. 23, 2021 (DE) 10 2021 003 228.4

(51) Int. Cl. C08G 65/48; C08J 5/22; H01M 4/62; H01M 50/414

(52) U.S. Cl. CPC C08G 65/48; C08J 5/2287; H01M 4/622; H01M 50/414; C08G 2650/40; C08J 2371/10

(57) ABSTRACT

The disclosure relates to a new substance class of high- and low-phosphonated aryl polymers and polymeric perfluorophosphonic acids, the starting material of which is their sulfonated form, and to a universal process for preparing phosphonated polymers from their sulfonic acid form and their uses in electromembrane applications.

### CROSS-REFERENCE TO RELATED APPLICATION

This application is a national stage application, filed under 35 U.S.C. § 371, of International Patent Application PCT/DE2022/100466, filed on Sep. 28, 2023, which claims the benefit of German Patent Application DE 10 2021 003 228.4 filed on Jun. 23, 2021.

### TECHNICAL FIELD

Novel phosphonated non-fluorinated and partially fluorinated aryl polymers from sulfonated aryl polymers and novel polymeric perfluorophosphonic acids from polymeric perfluorosulfonic acids, their preparation process and use in electromembrane applications.

### BACKGROUND

The most commonly described phosphonated polymer systems are based on aryl polymers synthesized by nucleophilic substitution (via Michaelis-Arbusow and Michaelis-Becker rearrangements) of aryl halides and di- or trialkyl phosphite.

These phosphonated aryl polymers have high thermal and chemical stability. In addition, they show good proton conductivity even in the non-humidified state.

The disadvantage of these phosphonated aryl polymers, e.g. from DE 10 2011 015 212 A1, is that they are extremely brittle in the non-hydrated state, i.e. dry state, and thus no functional membranes can be produced from them. The brittle behavior increases with increasing temperature and decreasing humidity, leading to mechanical failure of the membranes. This makes it impossible to use these polymers as membranes for electromembrane processes in the range above 100° C.

In U.S. Pat. No. 6,680,346B1 by Kyoji Kimoto, a direct synthesis to a phosphonated perfluorophosphonic acid is described. The claim refers to the following structure (FIG. 2) with the ratios m equal to 0 or 1, n equal to 2 or 3, X and Y equal —H or —C₆H₄S0₃H and the ratio of A/B equal to 1.5 to 15.

From EP2514773A1 it appears that the synthesized polymers in U.S. Pat. No. 6,680,346B1, due to polymerization conditions that are difficult to control, are subject to cyclisation leading to chain transfer during polymerization, causing a decrease in molecular weight and mechanical strength of the materials. As the molar ratio of short chain phosphonyl containing monomer to tetrafluoroethylene monomer increases, this side reaction is further promoted, limiting the increase in ion exchange capacity and material stability.

The process claimed here, does not have this limitation as polymeric perfluorosulfonic acids can nowadays be produced in consistent quality, examples of which can be seen in FIG. 1.

The described phosphonation reaction thus leads to a new stable material class of polymeric perfluorophosphonic acids and does not have the disadvantages of U.S. Pat. No. 6,680,346B1. The same applies to sulfonated aryl polymers; if the base polymer possesses good mechanical properties, it retains these in its new form as a phosphonated polymer.

### SUMMARY

The inventive step is based on finding and synthesizing new phosphonated polymers which are proton-conducting and chemically and mechanically stable even in the dry state. This is achieved by first converting sulphonated polymers, which already have good mechanical properties and sulphonic acid groups, into the —SO₂Cl form by sulphochlorination with thionyl chloride. Starting from the —SO₂Cl form, it is possible to phosphonate with trialkyl phosphites such as tris(trimethylsilyl)phosphite (TTMSP), or to convert the —SO₂Cl form with sodium sulphite into the —SO₂Na (sodium sulphonate) form and phosphonate the intermediate product, or further to convert the —SO₂Na form into the —SO₂Li (lithium sulphonate) form and phosphonate this product. With this process, phosphonated polymers with high mechanical flexibility, chemical stability and high proton conductivity can be synthesized from all polymers with sulfonic acid groups. The polymers, which already have good mechanical and chemical properties in their sulphonated form, retain these after phosphonation and, unlike the sulphonic acid containing polymers, also have high proton conductivity above 100° C. (FIG. 3)

The reaction should be as efficient and simple as possible, which is given here.

The phosphonated polymers should be soluble in common solvents in order to be able to produce membranes from them.

With the synthesis route described here, the phosphonated polymer can in principle be synthesized from all sulphonated polymers.

The invention is based on the insertion of a reactive group —X into a sulfonated polymer (—X can be —SO₂Cl, —SO₂Na, —SO₂Li) and the reaction of the reactive group with trialkyl phosphites such as TTMSP.

The phosphonated polymers may still contain free reactive groups —X, depending on the degree of phosphonation. Subsequently these free groups can be used to subsequently covalently crosslink the phosphonated polymers or to convert the unreacted groups back into the —SO₃H form and thus obtain a polymer containing both sulphonated and phosphonated groups.

The phosphonation can take place in solution. For this purpose, the polymers with the reactive group —X can be dissolved in solvents such as N-methylpyrolidone (NMP), dimethylacetamide (DMAc), dimethylsulphoxide (DMSO) etc. TTMSP can optionally be added before, directly during the dissolution process or after the polymers are dissolved. Depending on the desired degree of phosphonation, 0.1 wt. % (weight percent), low degree of phosphonation, to 5000 wt. %, high degree of phosphonation, TTMSP is added based on the weight of the polymer.

The reaction works best and fastest in high-boiling solvents such as NMP, DMAc and DMSO. During the reaction gas evolution can be observed, indicating the reaction start, no more gas evolution indicating the reaction stop.

The reaction is kept at reaction temperature (60° C. to 200° C.), depending on the polymer used, its molecular mass and solvent, until the gas evolution stops. Additionally the reaction is kept at reaction temperature for 2 to 8 hours to make sure that the reaction is complete.

Reaction byproducts and excess TTMSP are then removed by distillation, leaving the phosphonated polymer, in the form of trimethylsilylester, in the solvent.

The polymer solution is now added into water and depending on the degree of phosphonation, the polymer precipitates as a solid (low degree of phosphonation) or goes into solution (high degree of phosphonation). By heating the water/polymer mixture, the phosphonated polymer is hydrolysed from the trimethylsilylester form to free polymeric phosphonic acid.

To completely separate hydrolysis byproducts, the polymer can be washed with water, depending on the degree of phosphonation. Non-water-soluble polymer components can be washed with water and filtered off, water-soluble ones can be purified by dialysis.

Another variation is not to precipitate the polymer solution in water, after separating the excess TTMSP, the polymer solution is directly processed into a membrane and then hydrolyzed in overheated or boiling water or treated with hot steam.

A corresponding exemplary reaction overview of a non-limiting embodiment is shown in FIG. 4.

The polymers obtained can be blended with basic polymers, for example polybenzimidazole or anion exchange polymers, to form acid-base blend membranes, covalently crosslinked membranes and covalently crosslinked acid-base blend membranes.

The blend ratio between phosphonated and basic polymer can be between 99 mol % phosphonated polymer and 1 mol % basic polymer to 1 mol % phosphonated polymer and 99 mol % basic polymer.

An additional sulfonated polymer may be added to the polymer and blended in any amount.

The blend membrane can also be doped with any amount of phosphoric acid. Values between 40 wt. % and 500 wt. % are preferred as phosphoric acid doping levels.

The obtained polymers can be used in electrochemical cells. Preferably, the obtained polymers can be used in low or medium temperature fuel cells in the temperature range from −30° C. to 250° C. or in low or medium temperature electrolysers in the temperature range from 0° C. to 250° C. Furthermore, the obtained polymers can be used in chemical synthesis reactors from −70° C. to 250° C. The obtained polymers can also be used as separators in primary and secondary batteries or as binders in electrodes for primary and secondary batteries.

### BRIEF DESCRIPTION OF THE DRAWINGS

FIG. 1: Examples of polymeric perfluorosulphonic acids.

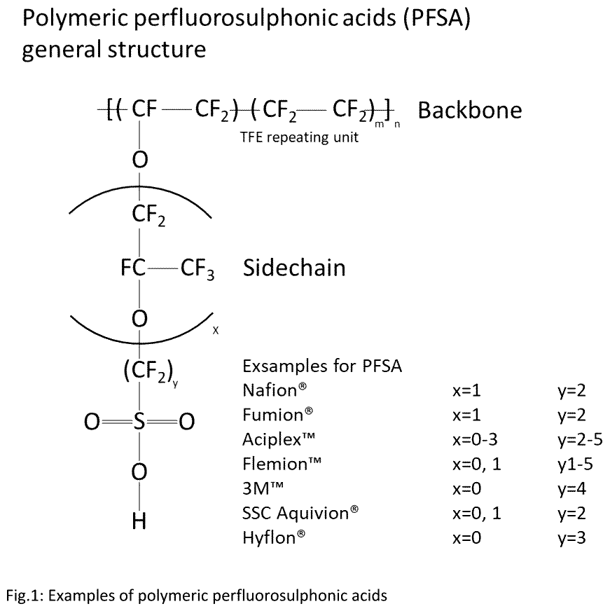

FIG. 2: Structure of the monomers from U.S. Pat. No. 6,680,346B1 for the synthesis of a perfluorophosphonic acid.

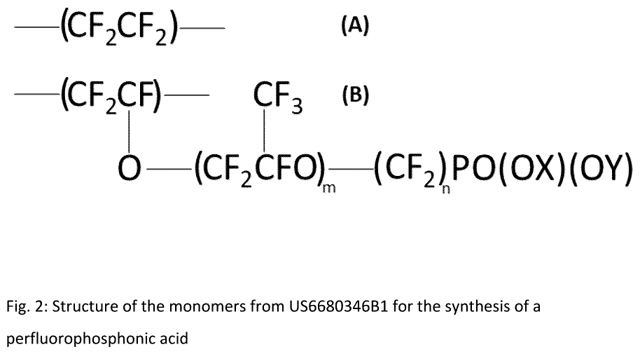

FIG. 3: Conductivity of phosphonated polymer pPEKEKK and Nafion® 212 compared at 50% RH at 30° C. decreasing to 0.2% RH at 180° C.

FIG. 4: Example of the reaction scheme for PEEK.

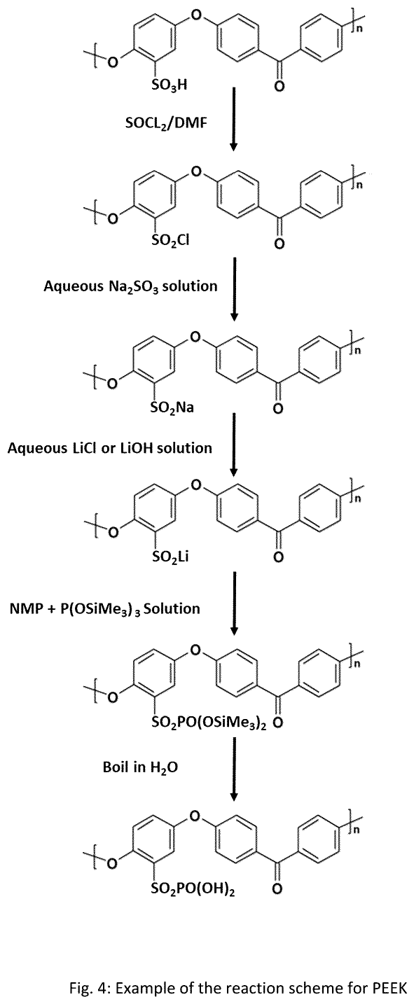

### DETAILED DESCRIPTION

### Non-Limiting Embodiment Example

2 g of a sulfonated polyetherketonetherketoneketone (sPEKEKK) is mixed with 55 g of thionyl chloride, heated to 90° C. and refluxed. DMF (dimethylformamide) is then added and heated until no gas evolution is observed. The reaction is then kept at reaction temperature for another 2 hours to ensure that the reaction is complete. Now the excess thionyl chloride and by-products are distilled and the product is slurried with THF (tetrahydrofuran). The solution/suspension can now be precipitated in isopropanol or water. The product is washed until neutral and then dried. Now the previously sulphonated polymer is present in the —SO₂Cl form. The product is converted to the —SO₂Na form in a 2 M sodiumsulphite solution. The polymer is filtered and washed again with water to wash out excess sodiumsulphite. A 10 wt % LiCl solution is then added to —SO₂Na form of the polymer to convert it to the —SO₂Li form. The polymer is then washed again with water to rinse out excess salts. Then the polymer is dried.

Phosphonation with TTMSP can be carried out with all three forms, —SO₂Cl, —SO₂Na and —SO₂Li, although the —SO₂Li form is preferred.

The polymer with —SO₂Cl, —SO₂Na or —SO₂Li groups can be mixed with organic solvents such as DMAc, NMP, DMSO etc. and TTMSP and be phosphonated.

For the polymeric perfluorosulfonic acids, the reaction can either be performed from the polymer granules, powder etc. as described before, or by using the perfluorosulfonic acid membrane directly. To do this, the perfluorosulfonic acid membrane is pulled through a hot thionyl chloride/DMF bath where the sulfochlorination takes place, then pulled through a water bath for rinsing.

The membrane, in the —SO₂Cl form, is then drawn through a sodium sulphite bath to form the —SO₂Na form and then rinsed with water. Then the membrane in the —SO₂Na form is pulled through a LiCl bath and transferred to the —SO₂Li form and then washed again in a water bath. All three forms —SO₂Cl, —SO₂Na and —SO₂Li, of the membrane can be drawn through a heated TTMSP bath and finally drawn through a hot/boiling water bath to obtain the phosphonic acid form by hydrolysis. This can be done in a continuous roll-to-roll process, but is also possible in a batch process. Now the membrane can be dried and further processed. Preferred is the phosphonation of the —SO₂Li form.

### Analysis of the Experiment:

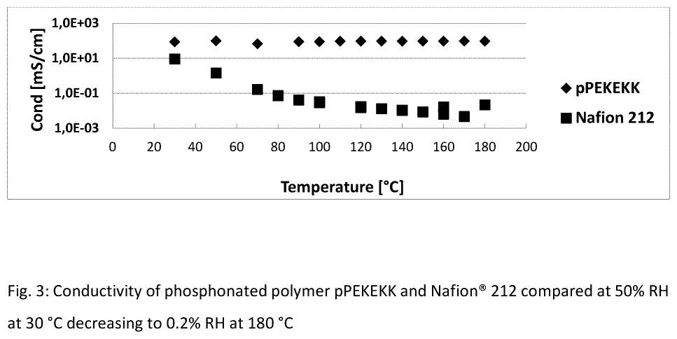

Description of one of the phosphonated polymers as an example, in terms of ion exchange capacity and conductivity up to 180° C. (FIG. 3).

### Determination of the Ion Exchange Capacity

100 mg of the prepared polymer are covered with a saturated NaCl solution, stirred for approximately 2 h and 2 drops of bromothymol blue are added as indicator. The protons of the phosphonated polymer exchange with the Na ions and HCl is formed. This HCl can be detected by titration with 0.1 mol NaOH and the IEC_{direct} can be determined. To determine the total IEC, 3 ml NaOH 0.1 M is added in excess to the solution, stirred again for 2 h and titrated back with HCl.

In the described experiment one obtains the phosphonated PEKEKK (pPEKEKK) with an IEC_{direct}=0.95 mmol/g and IECₜₒₜₐₗ=2.2 mmol/g. The good proton conductivity even above 100° C., can be seen well in the conductivity measurement in FIG. 3. In addition, as a reference Nafion 212 and its decrease in conductivity under the same measuring conditions at 50% RH at 30° C. decreasing to 0.2% RH at 180° C. can be seen in comparison (FIG. 3).

The high conductivity at high temperatures may be due to the fact that the SO₂ group has a strong pulling effect on the electrons of the phosphonic acid group.

1.-17. (canceled)

18. A method for preparing phosphonated polymers from raw polymers containing sulfonic acid groups, comprising:
a) converting a raw polymer selected from the group consisting of polyimides, polyether ketones (PEK), polyether ether ketones (PEEK), polyetherketoneetherketoneketone (PEKEKK), polycarbonates, polysulfones, polysulphoxides, polysulphides, non- and partially fluorinated polyether sulphones, non- and partially fluorinated polyether ether sulphones, polyesters, polystyrenes, and polymeric perfluorosulfonic acids to an —SO₂Cl form by sulphochlorination with thionyl chloride; and
b) reacting the —SO₂Cl form or an intermediate derived from the —SO₂Cl form with tris(trimethylsilyl)phosphite to form a phosphonated polymer.

19. The method according to claim 18, further comprising, after step a):
converting the —SO₂Cl form to an intermediate sodium form —SO₂Na by reaction with sodium sulphite.

20. The method according to claim 19, further comprising, after the converting to
the intermediate sodium form —SO₂Na:
converting the intermediate sodium form —SO₂Na to an intermediate lithium form —SO₂Li by reaction with lithium chloride or lithium hydroxide or another lithium salt.

21. The method according to claim 18,
wherein step b) is carried out in a solvent which is at least one member selected from the group consisting of N-methylpyrolidone (NMP), dimethylacetamide (DMAc), and dimethylsulfoxide (DMSO).

22. The method according to claim 21, further comprising:
heating the solvent to a boiling temperature of the solvent during step b).

23. The method according to claim 22, further comprising:
heating the solvent to the boiling temperature of the solvent for at least 2 hours.

24. The method according to claim 18, further comprising:
reacting, after step b), unreacted —SO₂Cl form back into the sulfonic acid groups.

25. The method according to claim 19, further comprising:
reacting, after step b), unreacted —SO₂Cl form or unreacted intermediate sodium form —SO₂Na back into the sulfonic acid groups.

26. The method according to claim 20, further comprising:
reacting, after step b), unreacted —SO₂Cl form or unreacted intermediate sodium form —SO₂Na or unreacted intermediate lithium form —SO₂Li back into the sulfonic acid groups.

27. The method according to claim 18,
wherein an amount of tris(trimethylsilyl)phosphite is 0.1 wt. % to 5000 wt. % of the intermediate.

28. The method according to claim 18,
wherein the raw polymer is in the form of a membrane, and
wherein the method is carried out by
immersing the membrane in the thionyl chloride, thereafter
rinsing the membrane by immersing the membrane in water, thereafter
immersing the membrane in the tris(trimethylsilyl)phosphite, and thereafter
rinsing the membrane by immersing the membrane in water.

29. The method according to claim 19,
wherein the raw polymer is in the form of a membrane, and
wherein the method is carried out by
immersing the membrane in the thionyl chloride, thereafter
rinsing the membrane by immersing the membrane in water, thereafter
immersing the membrane in the sodium sulphite, thereafter
rinsing the membrane by immersing the membrane in water, thereafter
immersing the membrane in the tris(trimethylsilyl)phosphite, and thereafter
rinsing the membrane by immersing the membrane in water.

30. The method according to claim 20,
wherein the raw polymer is in the form of a membrane, and
wherein the method is carried out by
immersing the membrane in the thionyl chloride, thereafter
rinsing the membrane by immersing the membrane in water, thereafter
immersing the membrane in the sodium sulphite, thereafter
rinsing the membrane by immersing the membrane in water, thereafter
immersing the membrane in dissolved lithium chloride or lithium hydroxide or another lithium salt, thereafter
rinsing the membrane by immersing the membrane in water, thereafter
immersing the membrane in the tris(trimethylsilyl)phosphite, and thereafter
rinsing the membrane by immersing the membrane in water.

31. Phosphonated polymers and membranes comprising:
a polymer that contains both sulfonic groups and phosphonic acid groups.

32. The phosphonated polymers and membranes according to claim 31,
wherein the polymer is a phosphonated polyetherketoneetherketoneketone (pPEKEKK).

33. An electrochemical cell comprising the phosphonated polymers and membranes according to claim 31.

34. A low or medium temperature fuel cell operating in a temperature range from −30° C. to 250° C., comprising the phosphonated polymers and membranes according to claim 31.

35. A low or medium temperature electrolysers operating in a temperature range from 0° C. to 250° C., comprising the phosphonated polymers and membranes according to claim 31.

36. A chemical synthesis reactors operating in a temperature range from −70° C. to 250° C., comprising the phosphonated polymers and membranes according to claim 31.

37. Separators in primary and secondary batteries comprising the phosphonated polymers and membranes according to claim 31.

38. Binders in electrodes, primary and secondary batteries comprising the phosphonated polymers and membranes according to claim 31.
